(19) United States
(12) Patent Application Publication
(10) Pub. No.: US 2017/0165701 A1
(43) Pub. Date: Jun. 15, 2017

(54) PAINT EDGER

(71) Applicant: Flock Development & Research Limited, Cheshire (GB)

(72) Inventor: Paul Constantine, Ashton-under-Lyne (GB)

(21) Appl. No.: 15/379,037

(22) Filed: Dec. 14, 2016

(30) Foreign Application Priority Data
Dec. 15, 2015 (GB) 1522131.0

(51) Int. Cl. B05C 1/00; B05C 17/00

(52) U.S. Cl. CPC B05C 1/00; B05C 17/00

(57) ABSTRACT

A paint edger 1 comprising: a body 5 having a feature arranged to contact a structure adjacent a surface to be painted to facilitate painting the surface close to the structure; and an applicator support 6 for supporting an applicator 7 for applying paint to the surface. The applicator support 6 and the feature are moveably mounted relative to one another.

### CROSS REFERENCE TO RELATED APPLICATIONS

This application claims priority from Great Britain application number 1522131.0, filed Dec. 15, 2015, the entire contents of each are hereby incorporated by reference herein.

### TECHNICAL FIELD OF THE INVENTION

The present invention relates to a paint edger, in particular to a paint edger that can be used to neatly paint a surface close to an adjacent structure.

### BACKGROUND TO THE INVENTION

Paint edgers are used to paint close to the edges of surfaces that are adjacent structures such as door frames and window frames.

A paint edger typically includes a flat foam applicator support mounted on a body that is attached to a handle. The applicator support carries an applicator for applying paint to a surface. The body has a feature, usually an overlapping edge and in some cases wheels, arranged to protrude a distance beyond the applicator.

In use, the feature of the body is pressed into contact with a structure adjacent the surface to be painted. This allows the applicator to apply paint near to the edge of the surface without the risk of painting the structure. Thus, a neat finish is provided at the edge of the surface. The user can run the paint edger along the surface whilst keeping the feature in contact with the structure so as to paint the whole of the surface near its edge adjacent the structure.

To load paint on to applicator the user must dip the paint edger into a tray that has been partly filled with paint. In order to ensure that the paint edger can provide a clean and precise finish, the user must dip the paint edger into the paint very carefully so as to not get paint on any part of the body, in particular on the protruding feature that contacts with the structure adjacent the surface. If paint comes into contact with the feature then the paint edger cannot provide a neat finish and must be cleaned with a cloth before use. This can make the use of paint edgers time-consuming and frustrating for a user.

Embodiments of the present invention seek to address the above problems.

### SUMMARY OF THE INVENTION

According to a first aspect of the present invention, there is provided a paint edger comprising: a body having a feature arranged to contact a structure adjacent a surface to be painted to facilitate painting the surface close to the structure; and an applicator support for supporting an applicator for applying paint to the surface. The applicator support and the feature are moveably mounted relative to one another.

In this way, the present invention provides a paint edger in which the applicator support can be moved, whilst mounted to the paint edger, relative to the feature of the body that is arranged to contact with a structure adjacent a surface to be painted. Thus, the applicator support can be moved to a second position away from and clear of the feature when loading paint on to the applicator. The applicator support can then be moved back to a first position towards the feature when painting so as to facilitate painting the surface close to an adjacent structure. Consequently, the risk of accidentally getting paint on the feature when loading paint on to the applicator is reduced. The paint edger can therefore be used to easily paint clean and precise lines along the edge of a surface adjacent a structure.

The feature may be an edge of the body. The feature may be at least one wheel mounted to the body. The feature may be two wheels mounted to the body. The wheel or wheels may be mounted at an edge of the body. The axis of the wheel or wheels may be substantially perpendicular to the body.

In this way, the wheels protrude from the body so that when the paint edger is pressed up into contact with a structure in use, the wheels displace the body and thus the applicator support at a distance away from the structure. This assists the user in painting near to the edge of a surface adjacent the structure without painting the structure itself. In addition, since the wheels turn, the paint edger can be held in to contact with the structure and moved along the surface to paint the whole of the edge of the surface adjacent the structure.

The paint edger may further comprise a biasing means for biasing the applicator support to move relative to the feature, between the first position and the second position. In particular, the biasing means may bias the applicator support from the second position into the first position. The biasing means may be connected between the body and the applicator support. The biasing means may be a spring; in particular, the biasing means may be a coil spring. The biasing means may be formed from steel.

In this way, the biasing means acts to retain the applicator support in its first position, housed in the body and near the feature, where the paint edger can be used to paint a surface.

The paint edger may further comprise a handle. The handle may be connected to the body. The handle may be substantially L-shaped. The handle may be formed with one or more integrated gripping portions its surface.

In this way, the handle provides a convenient means for the user to grip the paint edger.

The biasing means may be housed at least partly within the handle. The biasing means may be housed at least partly within the body. The biasing means may conveniently be housed at least partly within one or more tubular recesses formed within the handle and/or the body.

The handle may further comprise a socket for receiving an arm. The socket may be a pivotable and/or rotatable. The socket may be integrated into the handle. The socket may be integrated into a portion of the handle that is not connected to the body.

In this way, the socket allows for an arm to be attached to the paint edger to effectively extend the handle of the paint edger and allow it to be used to paint high surfaces.

The paint edger may further comprise a displacing means. The applicator support may be mounted on the displacing means for moving the applicator support relative to the feature, for example from a first position where the applicator support is near the feature to a second position where the applicator support is spaced away from the feature. The biasing means may act on a part of the displacing means in order to bias the applicator support and retain it in the first position near the feature. The displacing means may be integrated in to or substantially housed within the handle and/or the body. The displacing means may comprise a button or a trigger. The button may be substantially housed within the tubular recess in the handle and/or the body.

In this way, the biasing means may act on a button or trigger to force the applicator support to be retained in the first position near the feature, and the user may thus conveniently press the button or trigger in order to overcome the biasing force and displace the applicator support relative to the feature from its first position to its second position.

The body may comprise a substantially flat or planar body. The body may be substantially rectangular shaped of square-shaped.

The applicator support may be shaped to cooperate with the body. Thus the applicator support may be a substantially similar shape to the body. The applicator support may be a cuboid.

The paint edger may further comprise an applicator for applying paint to a surface. The applicator may be attached to the applicator support by an attachment means such as a hook and loop mechanism, or one or more clips. The applicator support and/or the applicator may be formed from foam. The applicator may comprise a plurality of bristles.

In this way, the applicator can be removed from the applicator support for washing or disposal after the paint edger has been used. A clean or new applicator can then be attached to the applicator support so that the paint edger can be reused.

### BRIEF DESCRIPTION OF THE FIGURES

In order that the invention may be more clearly understood an embodiment thereof will now be described, by way of example only, with reference to the accompanying drawings, of which:

FIG. 1 is a perspective view of a paint edger according to an embodiment of the invention, with the applicator support in the first position;

FIG. 2 is a perspective view of the paint edger shown in FIG. 1, but with the applicator support in the second position;

FIG. 3 is alternative perspective view of the paint edger shown in FIG. 2; and

FIG. 4 is a cross-section view of the paint edger shown in FIG. 1; the cross-section being at line A-A of FIG. 1.

### DETAILED DESCRIPTION OF THE INVENTION

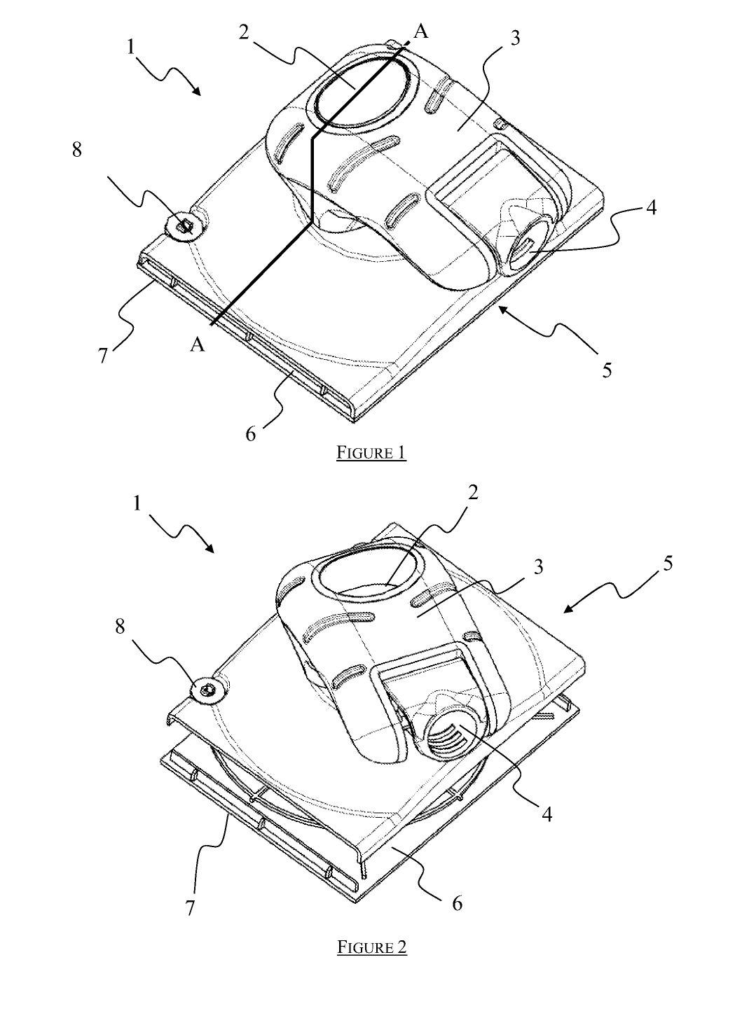

Referring to FIG. 1, a paint edger 1 comprises a substantially L-shaped handle 3 attached to a body 5 housing an applicator support 6. The handle 3 further comprises an integrally formed depressible button 2 and an integrally formed pivotable socket 4 for connecting the handle to an extending arm. In this embodiment, the body 5 is substantially flat and rectangular-shaped with two opposing edge portions that protrude perpendicularly and towards the applicator support 6. The body 5 thus forms a housing for the applicator support 6. The body 5 and applicator support 6 are mounted so as to be moveable relative to each other. The body 5 comprises a feature for contacting with a structure adjacent a surface to be painted so as to facilitate painting the surface close to the structure. In this embodiment, the feature is two wheels 8. The wheels 8 protrude beyond the applicator support 6 so as to provide a clearance between the edge of the body 5 and the edge of the applicator support 6. The applicator support 6 is substantially cuboid-shaped to correspond with the substantially rectangle-shaped body 5 in which it is housed. The applicator support 6 further comprises an applicator 7 for loading paint on to from a tray and for applying said paint to a surface. In this embodiment, the applicator 7 curves around the opposing sides of the applicator support 6 and is attached thereto by using a hook and loop mechanism. A coil spring 9 is located within the body 5 and the handle 3 to retain the applicator support 6 in a first position housed substantially in the body 5.

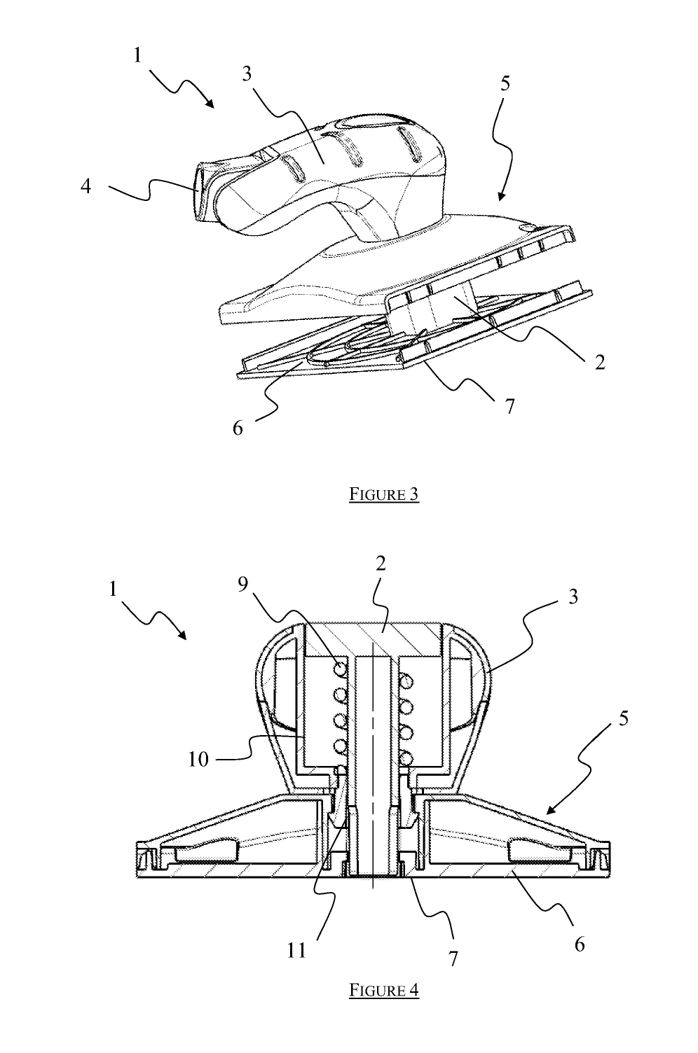

Referring to FIGS. 2 and 3, the paint edger of FIG. 1 is shown where the button 2, acting as a displacing means, has been depressed to force the applicator support 6 into a second position where it is displaced clear away from the body 5.

Referring to FIG. 4, the button 2 is substantially T-shaped and housed within a continuous tubular recess in the centre of the handle 2 and the body 5. The tubular recess has a first portion 10 having a larger diameter and a second tubular recess portion 11 having a narrower diameter. The base of the T-shaped button 2 is connected to the applicator support 6 and sits in the second tubular recess portion 11. The middle part and cross-member of the T-shaped button sit within the first tubular recess portion 10. The cross-member of the T-shaped button is shaped so as to be too large to fit through the second tubular recess portion 11.

A coil spring 9 is also housed within the first tubular recess portion 10. One end of the coil spring 9 abuts with the base of the first tubular recess portion 10. The other end of the coil spring 9 abuts with the inside of the cross-member of the T-shaped button, which is retained within the handle 3 by stops. Thus, the spring 9 pushes on the base of the first tubular recess portion 10 to bias the button 2 upwardly, which pulls the connected applicator support 6 upwards and retains it housed in the body 5 in the first position.

In use, the user picks up the paint edger 1 by gripping the handle 3 with their hand. The applicator support 6 is currently still in its first position retained within the body 5 by the biasing force of the spring 9 acting on the button 2. The button 2 is conveniently positioned where the user's thumb is located when the handle 3 is gripped.

The user depresses the button 2 with their thumb, which forces the button 2 downwards and towards the body 5, overcoming the force of the spring 9 that biases the button 2 upwards and holds the connected applicator support 6 in its first position. Thus, as the user presses the button 2 downwards in to the first tubular recess portion 10, the applicator support 6 begins to emerge from the body 5 in the same direction. When the button 2 is fully depressed and contacting with the base of the first tubular recess portion 10, the applicator support 6 is fully displaced downwards, and clear of, a plane defined by the orientation of the body 5. The user then dips the applicator support 6 into a tray that has been partly filled with paint so as to coat a surface of the applicator 7 with paint, without the wheels 8 or any other part of the body 5 contacting the paint.

The user slowly releases the button 2, and as they do so, the spring 9 biases the button 2 back upwards, which pulls the connected applicator support 6 upwards and back into its first position retained substantially within the body 5. The body 5 thus provides structural support to the applicator support 6. The user can then use the paint edger 1 to paint a wall with the paint that has been loaded on to the applicator 7.

The above embodiment is described by way of example only. Many variations are possible without departing from the scope of the invention as defined in the appended claims.

For example, although in the embodiment described above, the applicator support moves towards and away from the feature so that the applicator can be dipped in paint, in an alternative embodiment, it may be that the feature moves towards and away from the applicator support so that the applicator can be dipped in paint.

What is claimed is:

1. A paint edger comprising:
a body having a feature arranged to contact a structure adjacent a surface to be painted to facilitate painting the surface close to the structure; and
an applicator support for supporting an applicator for applying paint to the surface,
wherein the applicator support and the feature are moveably mounted relative to one another.

2. A paint edger according to claim 1, wherein the feature is an edge of the body.

3. A paint edger according to claim 1, wherein the feature is at least one wheel mounted to the body.

4. A paint edger according to claim 3, wherein the at least one wheel is mounted at an edge of the body.

5. A paint edger according to claim 1, further comprising a biasing means for moving the applicator support and the feature relative to one another.

6. A paint edger according to claim 5, wherein the biasing means biases the applicator support towards the feature.

7. A paint edger according to claim 5 wherein the biasing means is a spring.

8. A paint edger according to claim 1, further comprising a handle connected to the body.

9. A paint edger according to claim 8 when dependent on claim 5, wherein the biasing means is housed at least partly within the handle.

10. A paint edger according to claim 9 wherein the biasing means is housed at least partly within one or more tubular recesses formed within the handle.

11. A paint edger according to claim 10 wherein the biasing means is housed fully within one or more tubular recesses formed within the handle.

12. A paint edger according to claim 1, wherein the applicator support is mounted on a displacing means for moving the applicator support relative to the feature.

13. A paint edger according to claim 12 wherein the displacing means comprises a button or a trigger.

14. A paint edger according to claim 13 wherein the button or trigger is substantially housed within the handle.

15. A paint edger according to claim 14 wherein the button is substantially housed within the tubular recess in the handle.
